(19) United States
(12) Patent Application Publication
(10) Pub. No.: US 2015/0018047 A1
(43) Pub. Date: Jan. 15, 2015

(54) Apparatus and Method for Acquiring a Data Record, Data Record Distribution System, and Mobile Device

(71) Applicant: mr. qr10 GmbH & Co. KG, Berlin (DE)

(72) Inventors: Martin GELDERMANN, Linsengericht (DE); Viktor KISTER, Nidda (DE); Michael ROHBECK, Husby (DE)

(21) Appl. No.: 14/498,734

(22) Filed: Sep. 26, 2014

Related U.S. Application Data
(63) Continuation of application No. PCT/EP2013/056300, filed on Mar. 25, 2013.

(51) Int. Cl. G06F 17/30; H04M 1/725; G06Q 30/02

(52) U.S. Cl. CPC G06F 17/30743; G06Q 30/0239; H04M 1/72552
USPC 455/566; 707/758

(57) ABSTRACT

An apparatus for acquiring a data record includes a detecting interface configured for detecting an audio signal; an audio processor configured for processing the audio signal detected by the detecting interface and for extracting the code identifying the data record from the audio signal; a transmitting interface configured for transmitting the code extracted by the audio processor to a remote data record server; a receiving interface configured for receiving, from the remote data record server, the data record identified by the code; and an output interface for outputting the data record to a user.

### CROSS-REFERENCE TO RELATED APPLICATIONS

This application is a continuation of copending International Application No. PCT/EP2013/056300, filed Mar. 25, 2013, which is incorporated herein by reference in its entirety, and additionally claims priority from U.S. Application No. 61/616,229, filed Mar. 27, 2012, which is also incorporated herein by reference in its entirety.

### BACKGROUND OF THE INVENTION

The present invention relates to the acquisition of data records, particularly in the context of mobile devices and remote data servers. A particular application scenario is the distribution and acquisition of data records in the form of coupons.

Typically, coupons are transmitted to individuals by means of email or regular mail. This procedure is disadvantageous due to the fact that users often ignore these coupons, i.e. users deem received emails including coupons as spam email or individuals identify regular mail envelopes including coupons as advertising material only. The result is that individuals do not collect coupons and therefore do not behave as originally intended by those issuing these coupons.

A further disadvantage of such a distribution of coupons is that the coupon management is uncomfortable to the individual. In the case of paper coupons, the individual would have to collect this coupon at a safe place and would then have to think about the collected coupon when entering into a shop, for which the user has a coupon. In the case of paperless coupons in the form of emails or email attachments, the user equally has the problem of managing those coupons and using these coupons when needed.

Furthermore, this procedure is not only disadvantageous for the recipient of the coupon but also for those issuing the coupons, since these persons need to have mail addresses or email addresses of intended recipients. Furthermore, the selectivity for this kind of coupon distribution is very small. This means that coupons sent by email only make sense for larger companies having many shops or a very active internet shop in a certain geographical zone, such as a country. However, for smaller coupon providers such as smaller shops, etc. or for those managing cultural activities, the transmission of email coupons or mail coupons is not a good issue or it is, when it is done very selectively, too expensive.

Coupons are only specific examples for data records. Other data records may comprise texts, binary or source code programs, and other data records which are to be distributed from a data record management system to an individual user. Like coupons, such other data records also have the problems associated with distribution, such as safety, comfort, costs and speed.

### SUMMARY

According to an embodiment, an apparatus for acquiring a data record may have: a detecting interface configured for detecting an audio signal; an audio processor configured for processing the audio signal detected by the detecting interface and for extracting the code identifying the data record from the audio signal; a transmitting interface configured for transmitting the code extracted by the audio processor to a remote data record server; a receiving interface configured for receiving, from the remote data record server, the data record identified by the code; and an output interface for outputting the data record to a user.

Another embodiment may have a mobile device having an inventive apparatus for acquiring a data record.

According to another embodiment, a data record distribution system may have: a data record server configured for generating a code associated with a data record; a broadcasting module configured for receiving the code from the data record server and for generating an audio signal having the code embedded therewith and for broadcasting the audio signal; and a mobile device remote from the broadcasting module and the data record server, the mobile device including: a detecting interface configured for detecting the audio signal broadcast; an audio processor configured for processing the audio signal detected by the detecting interface and configured for extracting a code identifying the data record from the audio signal; a transmitting interface configured for transmitting the code to the data record server; a receiving interface configured for receiving, from the data record server, the data record identified by the code; and an output interface for outputting the data record to a user of the mobile device.

According to another embodiment, a method of acquiring the data record may have the steps of: detecting an audio signal; processing the audio signal detected by the detecting step and extracting the code identifying the data record from the audio signal; transmitting the code extracted to a remote data record server; receiving, from the remote data record server, the data record identified by the code; and outputting the data record to a user.

Another embodiment may have a computer program having a program code for performing, when running on a computer or a processor, an inventive method for acquiring a data record.

In accordance with the present invention, an apparatus or method is provided which is configured for acquiring a data record. The apparatus comprises a detecting interface configured for detecting an audio signal and a subsequently connected audio processor configured for processing the audio signal detected by the detection interface and configured for extracting the code identifying the data record from the audio signal. Furthermore, a transmitting interface configured for transmitting the extracted code to the remote data record server is provided. The apparatus or method additionally comprises a receiving interface configured for receiving, from the remote data server, the data record identified by the extracted code which has been transmitted to the remote data record server using the transmitting interface. Furthermore, an output interface for outputting the data record to a user is provided, and this output interface may be implemented as an acoustical output interface, such as a speaker and corresponding driver circuits or a display for optically displaying the data record to the user.

The present invention is particularly advantageous due to the fact that the code extraction from the audio signal which is typically a broadcast audio signal is done without any time delay. When the audio signal is output, for example, by speakers of a car stereo device, then the detecting interface which is included in a mobile device such as a smartphone immediately detects or records this audio signal and scans the detected audio signal for a code embedded into the audio signal. Hence, no user interaction is necessitated, since all of that is automatically done provided that the user has started the corresponding application (app) on her or his mobile device. As soon as a code is extracted, this code is, again without any user interaction, transmitted to the remote data record server and the remote data record server provides the complete data record identified by the code to the user device and the user device then automatically displays or outputs the data record in a certain way depending on the implementation. Therefore, the user receives without any interaction a data record display or acoustic output and the user can then select this data record or not. Therefore, the data record can be presented to the user quickly, and a region-specific user selection from the viewpoint of the remote data record server is easily obtainable as well due to the fact that broadcast signals are typically regionally provided programs rather than nationwide programs. Therefore, a quite region-specific distribution of data records to users can be obtained in a fully automatic way via an audio signal typically broadcasted and detected by the user device. Furthermore, the audio signal embedding technology and particularly the audio extraction technology can be made with high efficiency, i.e. with low additional costs due to the fact that not the whole data record is embedded and has to be extracted by the user device, but only a code, and typically an alphanumeric code is embedded, which only necessitates a low data rate and which only necessitates a moderate amount of processing resources for extracting. Due to the fact that the apparatus is implemented within a mobile device which is sold in large numbers, it is an advantage that the requirements for the mobile device are as small as possible, and typically the resources of the mobile device which are available anywhere, such as a transmitting interface and a receiving interface, are used. The transmission bandwidth is also small due to the fact that not the whole data record but only a code is to be transmitted, where the number of bits necessitated for the code is typically much lower than the number of bits necessitated for the whole data record. In embodiments, the ratio is 1:1000 or an even smaller ratio, such as 1:10000.

In an implementation, the data record is a coupon and the distribution of the coupons for the remote data record or coupon server on the one hand and the management and usage of the coupons for the user of the apparatus for acquiring a data record on the other hand are both cost-effective and compatible.

### BRIEF DESCRIPTION OF THE DRAWINGS

Embodiments of the present invention will be detailed subsequently referring to the appended drawings, in which:

FIG. 1 is a block diagram of an implementation of an apparatus for acquiring a data record;

FIG. 2 is a flowchart of a method for acquiring a data record; and

FIG. 3 is a functional block diagram for a data record distribution system.

### DETAILED DESCRIPTION OF THE INVENTION

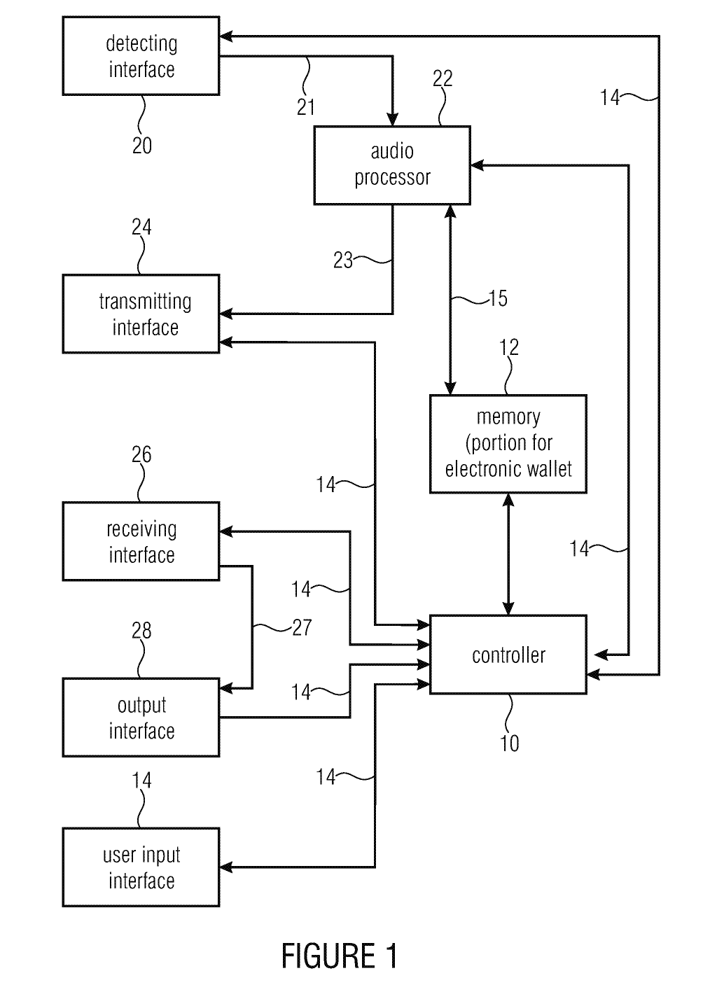

FIG. 1 illustrates an apparatus for acquiring a data record, where the data record can for example be a coupon or any other data record which has usefulness to the user and for which the remote data record server has an interest to distribute this data record to the user either for free or against a payment.

The apparatus comprises a detecting interface 20 configured for detecting an audio signal. Furthermore, the apparatus comprises an audio processor 22 configured for processing the audio signal detected by the detection interface and for extracting a code identifying the data record from the audio signal. Therefore, the detected audio signal is provided from the detecting interface to the audio processor via line 21 and the extracted code is provided from the audio processor 22 via line 23 to a transmitting interface 24. The transmitting interface is configured for transmitting the code to a remote data record server. In response to the received code, the remote data record server (not illustrated in FIG. 1) sends the data record identified by the code back to the apparatus illustrated in claim 1 and the apparatus receives the data record via a receiving interface 26 configured for receiving, for the remote data server, the data record identified by the code. The received data record is then provided via a line 27 to an output interface 28 which is configured for outputting the data record to a user.

An implementation of the inventive apparatus/method is for distributing coupon codes via an audio transmission in a radio and particularly a broadcast radio. Further applications additionally include radio transmitters and television transmitters.

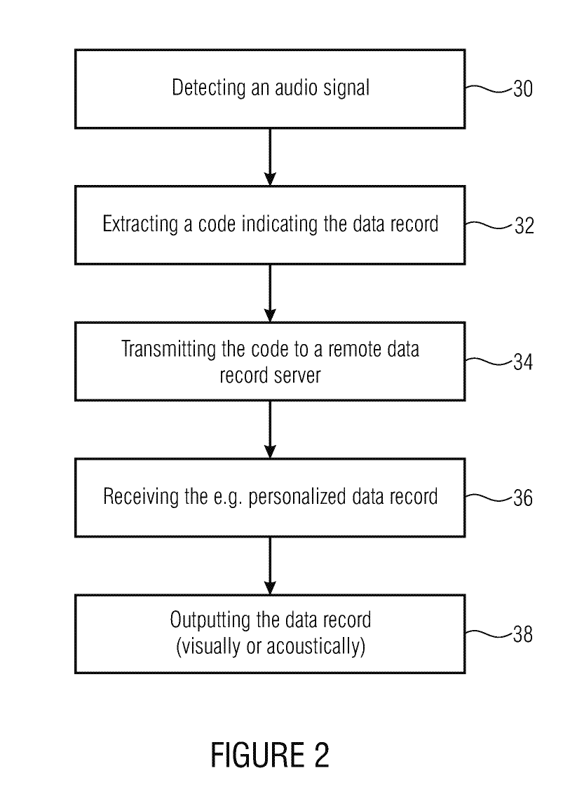

FIG. 2 illustrates an implementation of an inventive method for acquiring a data record. In step 30, an audio signal is detected. Then, in step 32 a code indicating the data record is extracted from the audio signal detected in step 30. In step 34, the code is transmitted to a remote data record server. Subsequently, in step 36 the data record is received from the remote data server and this data record can, in an embodiment, be a personalized data record. In step 38, the data record is then output, and this output may comprise a visual output or an acoustic output.

Advantageously, the apparatus illustrated in FIG. 1 is implemented in a mobile device, and the apparatus, particularly when being implemented in a mobile device comprises a controller 10 and a memory 12. Furthermore, the apparatus illustrated in FIG. 1 comprises a user input interface 14, where a user can input a request, a confirmation or anything like that so that the controller 10 can detect the user request input into the user input interface 14. Furthermore, all devices in FIG. 1 are connected to the controller 10 via control lines 14, and the controller particularly controls the cooperation of the individual devices in order to implement the inventive method as exemplarily illustrated in FIG. 2.

In an implementation of the present invention, the memory 12 is configured for storing an audio signal detected by the detecting interface 20 so that the audio processor 22 can operate on the stored audio signal via the memory connection 15. Furthermore, the memory 12 is configured for providing a memory portion for an electronic wallet, in which the data records, and coupons as data records, can be stored as soon as the user has input a certain command into the user input interface 14.

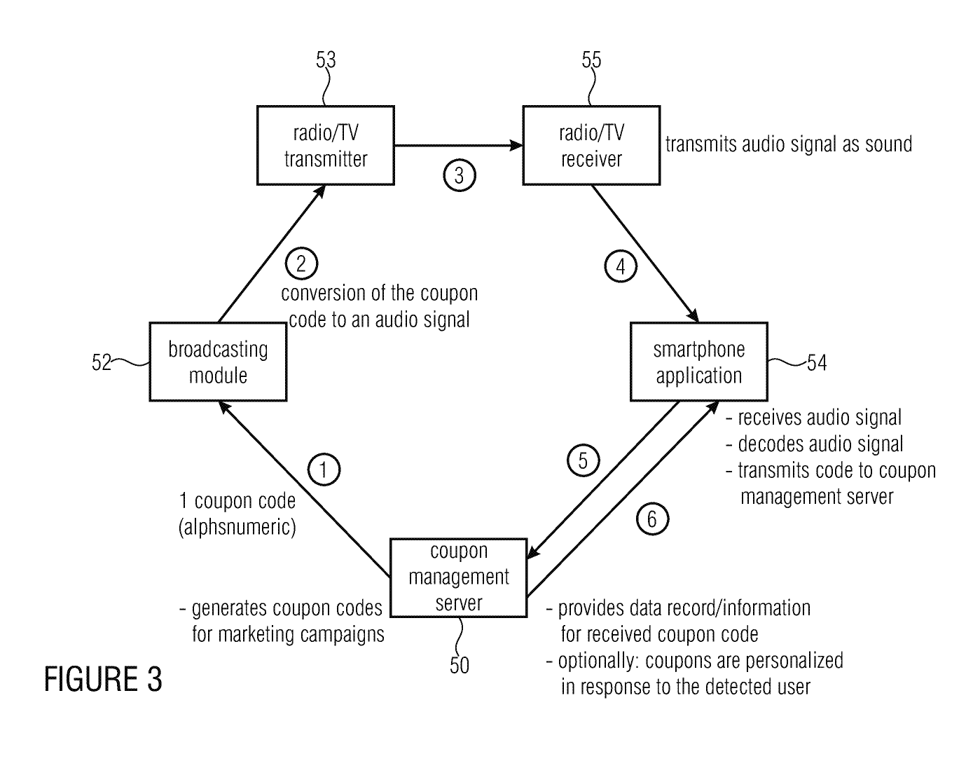

Subsequently, an implementation of the present invention is illustrated in the context of FIG. 3 and the other figures.

A data record distribution system comprises a data record server configured for generating a code associated with a data record, and this data record server may be a coupon management server 50 of FIG. 3. Furthermore, the data record distribution system illustrated in FIG. 3 as an implementation for distributing coupons as their records comprises a broadcasting module 52 configured for receiving the code from the data record server 50 and for generating an audio signal having the code embedded therewith and for broadcasting this audio signal. To this end, the broadcasting module can be connected to a radio TV transmitter 53 or the broadcasting module 52 and the radio/TV transmitter 53 may be implemented in a single broadcasting module entity.

Furthermore, the apparatus illustrated in claim 1 can be implemented as a mobile device, and particularly as a smartphone application illustrated at 54. Additionally, a radio/TV receiver, for example in a car or in the same mobile device, may be provided as illustrated at 55. However, the radio TV receiver is separate from the mobile device or the smartphone application 54 so that the general interface between the radio TV receiver 55 and the smartphone application 54 is via speakers connected to the radio TV receiver and a microphone receiving sound emitted by the speakers, where this microphone is included in the mobile device, and particularly a smartphone, in which the smart application 54 is implemented.

Hence, a data record distribution system consists of a centralized system for managing the codes, a module for converting alphanumeric codes in audio signals and a smartphone application for converting the audio signal in a generalized or personalized coupon code. This system is intended for distributing coupons for specific actions, such as discounts, particular treatments such as VIP treatments or so to listeners during advertisement spots in radio or TV programs.

To this end, the code which is generated within the data record manager 50, is converted into an audio signal by the broadcasting module 52. The audio signal is played as a part of the advertisement spot or the audio signal is generally introduced into an audio transmission. For decoding and finally acquiring the coupon, the listener can use an application program, which on the one hand provides a connection to the data record distribution system or coupon management server and which on the other hand detects the audio transmission whether the audio transmission comprises coupon codes.

As soon as a listener switches on the app during an audio transmission, and when the user receives the audio transmission via the microphone, coupon codes can be accepted. As soon as the coupon code is transmitted in the form of an audio sequence within an advertisement or within any other portion of the program, the smartphone application detects this coupon code due to its specific features. The application then retrieves, via the coupon management server, the necessiated information to the transmitted coupon code and displays this information, i.e. the data record, on a display of the smartphone or acoustically outputs this data, i.e. by reading the data to the user. The listener can then, after having understood the information, select whether she or he wishes to store the coupon in a coupon wallet on the smartphone for later usage.

The later usage of the coupon code is done via standard processes. The coupons/discounts or value codes can be used for shopping, for receiving services in the online as well as the stationary trade and service market.

Particularly, the broadcasting module 52 is configured for generating the audio signal in such a way that an audio signal is generated using the multi-digit alphanumeric code which has been generated by the coupon management server. This audio signal is generated in such a way that it is either included in the running audio transmission in an embedded mode, i.e., that it is below the threshold and, particularly, below the listening threshold, or the audio signal is in separate transmission sequences. In order to ease the detection by the smartphone and in order to minimize transmission difficulties, the audio signal can be transmitted via the advertisement before or afterwards several times so that the smartphone application can detect the audio signal multiple times until an error-free detection.

One can also use a sequence of the transmitted program contents such as a melody or a spoken text as an audio signal including the coupon code. The decoding and transmission of the coupon code takes place as described.

Subsequently, the main features of the present invention are summarized. In a first step, the coupon management server generates a coupon code which can be an alphanumeric code for a marketing campaign.

Then, this coupon code is transmitted to the program provider, who is to distribute the campaign. Then, the program provider converts the coupon code to an audio signal using the broadcasting module 52. Here, it is selected in which form the audio signal is to be generated. That can be, for example, a simple tone sequence, but there are also other ways to do so. One way is to generate the sound signal on frequencies, which are included below the threshold into the running transmission. Another alternative is to link the audio signal with a certain text or music sequence which is part of the audio transmission and which is to be detected as an audio code within the audio processor 22 of FIG. 1, for example. A further alternative is the link with a sound logo which represents a certain coupon code in a timely limited manner. The period of validity (link with the sound logo) is managed by the coupon management server and is also controlled by the coupon management server.

A coupon management server manages the stored information for the coupon codes and the correspondingly set variable validity windows.

Then, the broadcasting module 52 provides the audio codes and, particularly, the audio signals comprising the codes to the radio/TV transmitter 53 which then introduces this data on the sound side into the radio/TV program.

In the running radio/TV program, audio codes are transmitted and are output via speakers of a radio/TV receiver 55 of FIG. 3 as an acoustical sound signal or audio signal.

Then, the smartphone application 54 detects the audio signal via a microphone and receives the audio signal directly and samples this audio signal in order to find known audio signals. The audio signals are introduced via a certain tone sequence and are, therefore, made detectable.

The smartphone application then transmits each detected audio code to the coupon management server and receives, as a response, the content of the coupon code with the campaign details. This information is displayed via the display of the smartphone or is acoustically rendered, i.e., read to the user, or both kinds of output are applied.

The listener of the program and the user of the smartphone application can then decide whether he wants to have the coupon in her or his personal coupon wallet or electronic wallet (illustrated at 12 in FIG. 1).

After the storage, the user can then use the coupon later on when she or he intends to buy wares or services online or at stationary shops.

Subsequently, other embodiments are discussed.

The coupon code is an alphanumeric code, i.e., consists of letters or numbers or both. Furthermore, the alphanumeric code can also include special characters such as comma, brackets, etc. In this implementation, the audio processor 22 is configured for extracting the alphanumeric code.

In a further implementation of the present invention, the output interface 28 is furthermore configured to output to the user an information requesting information from the user, whether the user intends to accept the data record. In this implementation, the apparatus furthermore comprises the user input interface 14 for receiving a user reply indicating that the user wishes to accept the data record. Furthermore, the apparatus is configured to store the data record in a data record storage 12 of FIG. 1 only in response to a user reply indicating that the user does wish to accept the data record.

Furthermore, the detecting interface 20 may comprise a microphone and a subsequently connected analog/digital converter for converting a digital version of the audio signal. Alternatively or additionally, the detecting interface 20 may comprise an AM/FM tuner for demodulating a broadcast audio signal. Again alternatively or additionally, the detecting interface may comprise a packet receiver for receiving a stream of packets from the internet, where the stream of packets represents an internet broadcast stream of a radio or television program.

In a further implementation, the audio processor 22 is configured to perform a pattern matching with the audio signal, wherein a plurality of different patterns are associated with the plurality of different codes. Alternatively or additionally, the audio processor comprises a watermark extractor for extracting the code from the audio signal, the code being embedded into the audio signal so that a listener listening to the audio signal does not perceive that the code is embedded in the audio signal. Watermark embedding and, particularly how it is done and how the watermarks are extracted is well-known in the art.

In a further embodiment, the apparatus, and specifically, the mobile device in a smartphone application further comprises an output interface for outputting the data record to a remote destination entity being different from the user and the remote data server. This remote destination entity may, for example, be an internet or a stationary shop, where the data record or coupon code is accepted and where a discount or specific service is provided in exchange to the coupon code. This functionality is connected with the electronic wallet functionality illustrated at 12 in FIG. 1, so that the user of the smartphone can use the codes as soon as he is in a certain, for example, near-field connection to a point of sale or service accepting the coupon so that the coupon can be used in the same way as money within an electronic purse.

The data record server is configured for generating a personalized data record in response to receiving the code from the mobile device, wherein the personalized data record comprises an ID of a user of the mobile device, and wherein the mobile device is configured to transmit the ID of the user of the mobile device to the data record server together with the code.

Furthermore, the data record server is configured for storing information on a limited validity period in association with the data record and the data record server is furthermore configured for checking whether the limited validity period has not expired, in response to a received code and the data record server only sends back the data record when the limited validity period has not expired. Alternatively or additionally, the data record itself is provided with a validity period, and this validity period is attached to the data record in a certain way such as using encryption technology or digital signature technologies. Then, the electronic wallet implemented in the memory 12 of the apparatus of FIG. 1 automatically checks the stored coupons whether a validity of a coupon has expired. In this case, the electronic wallet then can automatically delete this coupon from the electronic value. Alternatively or additionally, the electronic wallet functionality warns the user in advance of the expiration time that the coupon is expiring soon and that the coupon should be used as soon as possible.

Depending on certain implementation requirements, embodiments of the invention can be implemented in hardware or in software. The implementation can be performed using a non-transitory storage medium or a digital storage medium, for example a floppy disk, a BD, DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a non-transitory data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for acquiring a data record comprising:
a detecting interface configured for detecting an audio signal;
an audio processor configured for processing the audio signal detected by the detecting interface and for extracting the code identifying the data record from the audio signal;
a transmitting interface configured for transmitting the code extracted by the audio processor to a remote data record server;
a receiving interface configured for receiving, from the remote data record server, the data record identified by the code; and
an output interface for outputting the data record to a user.

2. Apparatus of claim 1, in which the code is an alphanumeric code and in which the audio processor is configured for extracting the alphanumeric code from the audio signal.

3. Apparatus of claim 1, in which the data record is a textual coupon, and in which the receiving interface is configured for receiving the textual coupon, and in which the output interface is configured for visually or acoustically outputting the textual coupon.

4. Apparatus in accordance with claim 1, in which the output interface is furthermore configured to output to the user an information requesting information from the user, whether the user intends to accept the data record, and wherein the apparatus furthermore comprises an input interface for receiving a user reply indicating that the user wishes to accept the data record, and wherein the apparatus is furthermore configured to store the data record in a data record storage only in response to a user reply indicating that the user wishes to accept the data record.

5. Apparatus in accordance with claim 1,
wherein the detecting interface comprises a microphone and an analog/digital converter for generating a digital version of the audio signal, or
wherein the detecting interface comprises an AM or FM tuner for demodulating a broadcast audio signal, or
wherein the detecting interface comprises a packet receiver for receiving a stream of packets from the internet, the stream of packets representing an internet broadcast stream of a radio or television program.

6. Apparatus in accordance with claim 1,
wherein the audio processor is configured to perform a pattern matching with the audio signal, wherein a plurality of different patterns are associated with a plurality of different codes, or
wherein the audio processor comprises a watermark extractor for extracting the code from the audio signal, the code being embedded into the audio signal, so that the listener listening to the audio signal does not perceive that the code is embedded in the audio signal.

7. Apparatus in accordance with claim 1, further comprising an additional output interface for outputting the data record to a remote destination entity being different from the user and being different from the remote data server.

8. Mobile device comprising an apparatus for acquiring a data record in accordance with claim 1.

9. Mobile device of claim 8,
wherein the detecting interface comprises a microphone of the mobile device,
wherein the audio processor is implemented by a mobile device processor,
wherein the transmitting interface is a transmission interface of the mobile device configured for performing a telephone connection or a data connection with a further mobile device,
wherein the receiving interface is a receiving interface of the mobile device configured for performing a telephone connection or a data connection with a further mobile device, and
wherein the output interface comprises a display or a speaker of the mobile device.

10. Data record distribution system, comprising:
a data record server configured for generating a code associated with a data record;
a broadcasting module configured for receiving the code from the data record server and for generating an audio signal comprising the code embedded therewith and for broadcasting the audio signal; and
a mobile device remote from the broadcasting module and the data record server, the mobile device comprising:
a detecting interface configured for detecting the audio signal broadcast;
an audio processor configured for processing the audio signal detected by the detecting interface and configured for extracting a code identifying the data record from the audio signal;
a transmitting interface configured for transmitting the code to the data record server;
a receiving interface configured for receiving, from the data record server, the data record identified by the code; and
an output interface for outputting the data record to a user of the mobile device.

11. Data record distribution system of claim 10,
in which the broadcasting module is configured for generating a plurality of audio signals at different points in time, where each of the plurality of audio signals comprises the same code embedded therewith.

12. Data record distribution system of claim 10,
wherein the data record server is configured for generating a personalized data record in response to receiving the code from the mobile device, wherein the personalized data record comprises an identification of a user of the mobile device, and wherein the mobile device is configured to transmit the identification of the user of the mobile device to the data record server together with the code.

13. Data record distribution system of claim 10,
wherein the data record server is configured for storing information on a limited validity period in association with the data record and for checking whether the limited validity period has not expired, in response to the received code, and of only sending the data record to the mobile device, when the limited validity period has not expired.

14. Method of acquiring the data record, comprising
detecting an audio signal;
processing the audio signal detected by the detecting step and extracting the code identifying the data record from the audio signal;
transmitting the code extracted to a remote data record server;
receiving, from the remote data record server, the data record identified by the code; and
outputting the data record to a user.

15. Computer program comprising a program code for performing, when running on a computer or a processor, a method for acquiring a data record in accordance with claim 14.
